(19) United States
(12) Patent Application Publication
(10) Pub. No.: US 2014/0188554 A1
(43) Pub. Date: Jul. 3, 2014

(54) Priority-Weighted Selection to Match a Panelist to a Market Research Project

(71) Applicant: e-Rewards, Inc., (US)

(72) Inventors: James Sterling Shapiro Harter, Lantana, TX (US); Stephen Allen Myers, Dallas, TX (US); Eric Steven Herfield, Plano, TX (US); Jeremy Scott Antoniuk, Allen, TX (US); Melanie Denise Courtright, Rowlett, TX (US); Daren Moneta, Dallas, TX (US); Peter David Flower, London (GB)

(73) Assignee: e-Rewards, Inc., Plano, TX (US)

(21) Appl. No.: 13/733,082

(22) Filed: Jan. 2, 2013

(51) Int. Cl. G06Q 30/02

(52) U.S. Cl. CPC G06Q 30/0201
USPC 705/7.29

(57) ABSTRACT

A method of matching a panelist to a market research project includes accessing, by one or more computer processors, a set of quota cells identified for the panelist and having priorities assigned thereto. The method additionally includes selecting, by the one or more computer processors, a market research project by weighting random selection of market research projects according to the priorities assigned to their respective quota cells identified for the panelist. The method further includes matching, by the one or more computer processors, the panelist to the market research project based on the selection.

### TECHNICAL FIELD

This disclosure is generally directed to matching a panelist to a market research project. This disclosure is specifically directed to priority-weighted quota cell selection to match a panelist to a market research project.

### BACKGROUND

Market research is an organized effort to gather information about markets or customers. Market research can include social and opinion research performed to systematically gather and interpret information about individuals or organizations using statistical and analytical methods and techniques of the applied social sciences to gain insight or support decision making. Viewed as an important component of business strategy, market research can be a key factor to obtain advantage over competitors. Market research provides important information to identify and analyze market need, market size, and competition.

Quantitative marketing research is the application of quantitative research techniques to the field of marketing. It has roots in both the positivist view of the world, and the modem marketing viewpoint that marketing is an interactive process in which both the buyer and seller reach a satisfying agreement on the “four Ps” of marketing: Product, Price, Place (location), and Promotion. As a social research method, it typically involves the construction of questionnaires and scales. People who respond (respondents) are asked to complete the survey. Marketers use the information so obtained to understand the needs of individuals in the marketplace, and to create strategies and marketing plans.

In market research, projects are defined for supplying a market research sample to a customer having a survey that needs to be completed by panelists having certain targeted attributes. Generally speaking, a project has a deadline for survey completion, and a set of criteria to fulfill in terms of the targeted attributes. An example target attribute for a survey might be “includes owners of vehicle model X,” thus defining a requirement that 100% of panelists have this attribute. Another example target attribute for a survey might be “excludes drivers over age 40,” thus defining a requirement that 0% of panelists have the attribute of being over age 40.

On the other hand, other criteria for a project may involve quotas for certain demographics, such as 45%-55% male and 45%-55% female. These demographic quotas help prevent skew in the results, and are grouped together. For example, the aforementioned set of demographics defines a quota group for the project, with the % male and % female panelists each being a quota cell in that quota group. Another quota group might be defined as 45%-55% eastern US residents and 45%-55% western US residents. These quota groups may be independent of one another, in which case the customer does not mind if 100% of the male respondents are from the Eastern US, etc. Alternatively, the quota cells of a group may be “nested” (AKA “interlocked”), in which case two groups each having two quota cells may be replaced by a single quota group having four nested quota cells as follows: 22.5%-27.5% male, eastern US residents; 22.5%-27.5% female, eastern US residents; 22.5%-27.5% male, western US residents; 22.5%-27.5% female, western US residents. A project may have multiple quota groups, some of which may quota cells nested therein.

The task of supplying the sample for a project has previously been addressed by using a relational database to find panelists having attribute values that match the values of the targeted attributes of a project. In this sense, panelists may be potential respondents who have enrolled as panelists and therefore have one or more of their attribute values recorded in the relational database. It is envisioned that panelists may be members of one or more proprietary market research access panels, or may have been sourced elsewhere, such as dynamically sourced through a network of website properties or from a third party access panel. It is also envisioned that panelists may be newly enrolling or not yet enrolled panelists. For a particular project, the panelists having the attribute values are then sent emails that provide a link to a survey associated with that project. A panelist may respond to such an email after that panelist is no longer needed for that project. In the past, such a panelist may then be matched to another project having a high acceptance rate, in the same or similar way that newly enrolled panelists are handled. However, it would be advantageous to match returning panelists or newly enrolled panelists to projects having relatively low acceptance rates, thus making more effective use of the panelists. It would also be advantageous to make more efficient use of panelists who fail to qualify for a survey by rerouting such panelists to another survey. The present disclosure is directed toward providing such a solution.

### BRIEF SUMMARY

In some aspects, a method of matching a panelist to a market research project includes accessing, by one or more computer processors, a set of quota cells identified for the panelist and having priorities assigned thereto. The method additionally includes selecting, by the one or more computer processors, a market research project by weighting random selection of market research projects according to the priorities assigned to their respective quota cells identified for the panelist. The method further includes matching, by the one or more computer processors, the panelist to the market research project based on the selection.

In other aspects, an apparatus for matching a panelist to a market research project has means for accessing, by one or more computer processors, a set of quota cells identified for the panelist and having priorities assigned thereto. The apparatus additionally has means for selecting, by the one or more computer processors, a market research project by weighting random selection of market research projects according to the priorities assigned to their respective quota cells identified for the panelist. The apparatus further has means for matching, by the one or more computer processors, the panelist to the market research project based on the selection.

In additional aspects, a computer program product, includes a non-transitory computer-readable medium. The non-transitory computer-readable medium includes code for causing a computer processor to access a set of quota cells identified for the panelist and having priorities assigned thereto. The non-transitory computer-readable medium additionally includes code for causing a computer processor to select a market research project by weighting random selection of market research projects according to the priorities assigned to their respective quota cells identified for the panelist. The non-transitory computer-readable medium further includes code for causing a computer processor to match the panelist to the market research project based on the selection.

In other aspects, a market research apparatus includes a memory that stores data relating to panelists and market research projects, and a processor configured to access a set of quota cells identified for the panelist and having priorities assigned thereto. The processor is additionally configured to select a market research project by weighting random selection of market research projects according to the priorities assigned to their respective quota cells identified for the panelist. The processor is further configured to match the panelist to the market research project based on the selection.

In further aspects, a method of finding a first data item within a set based on a second data item includes accessing, by one or more computer processors, a set of criteria data items identified for the second data item, wherein the criteria data items represent criteria for matching the second data item to the first data items, and wherein the criteria data items have priorities assigned thereto. The method additionally includes selecting, by the one or more computer processors, a first data item by weighting random selection of first data items according to the priorities assigned to their respective criteria data items identified for the second data item. The method further includes, matching, by the one or more computer processors, the second data item to the first data item based on the selection.

In yet further aspects, an apparatus for finding a first data item within a set based on a second data item includes means for accessing, by one or more computer processors, a set of criteria data items identified for the second data item, wherein the criteria data items represent criteria for matching the second data item to the first data items, and wherein the criteria data items have priorities assigned thereto. The apparatus additionally includes, means for selecting, by the one or more computer processors, a first data item by weighting random selection of first data items according to the priorities assigned to their respective criteria data items identified for the second data item. The apparatus further includes means for matching, by the one or more computer processors, the second data item to the first data item based on the selection.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying FIGURES, in which:

FIG. 1 is a flow diagram illustrating a method of matching a panelist to a market research project in accordance with the present disclosure;

FIG. 2 is a block diagram illustrating an apparatus for matching a panelist to a market research project in accordance with the present disclosure;

FIG. 3 is a flow diagram illustrating a method of operation for a market research apparatus in accordance with the present disclosure;

FIG. 4 is a flow diagram illustrating a method of weighting random selection of one or more market research projects according to priorities assigned to the their respective quota cells identified for the panelist in accordance with the present disclosure; and

FIG. 5 is a block diagram illustrating data structures and objects generated and utilized by a computer implemented process executed according to the method of FIG. 4.

### DETAILED DESCRIPTION

As will be further explained below, the present disclosure is generally related to finding a first data item within a set based on a second data item. For example, the one or more computer processors access a set of criteria data items identified for the second data item, wherein the criteria data items represent criteria for matching the second data item to the first data items, and wherein the criteria data items have priorities assigned thereto. Additionally, the one or more computers select a first data item by weighting random selection of first data items according to the priorities assigned to their respective criteria data items identified for the second data item. Also, the one or more computers match the second data item to the first data item based on the selection. Further, the one or more computers may assign priorities to the criteria data items based on one or more of scarcity of their respective first data items, schedules for finding their respective first data item; or scarcity of second data items that satisfy the criteria of the respective data items.

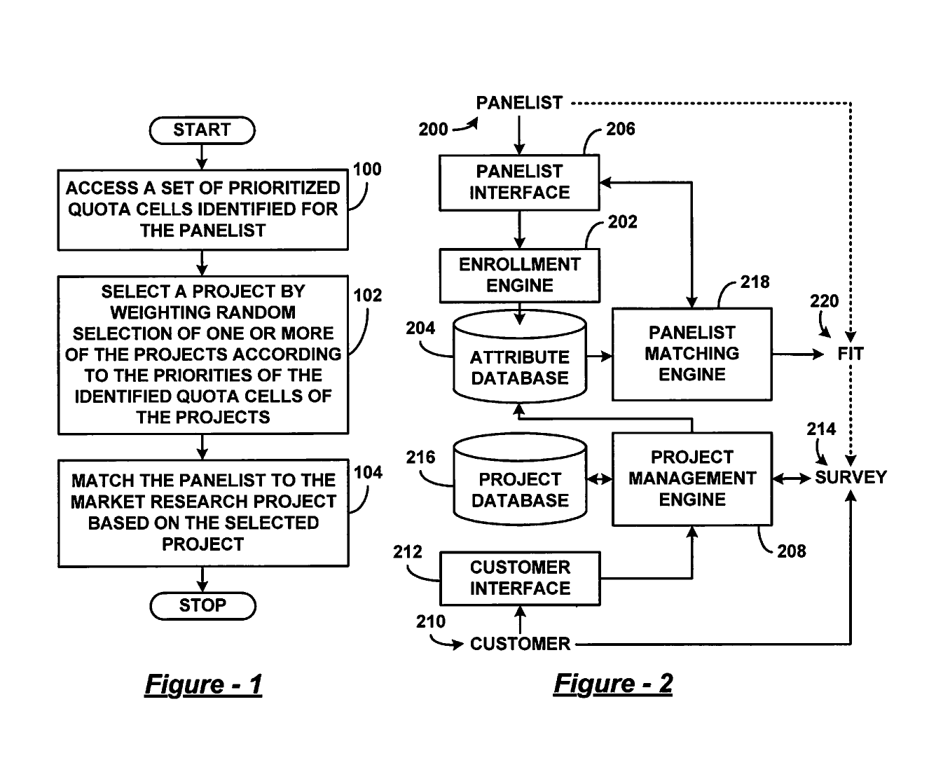

In particular aspects described below with reference to FIGS. 1-5, an example implementation is set forth that addresses the task of matching a panelist to a market research project. For example, in these aspects, the first data item represents a market research project, and the second data item represents a panelist. Additionally, in these aspects, the criteria data item represents a quota cell, and the scarcity of the first data items corresponds to percentage of progress, which correlates to the market research project being overly abundant if the percentage of progress is low. Thus, more abundant first data items may be found for second data items having attribute values that fulfill the criteria of the first data items. Further, in these aspects, schedules for finding the first data items may correspond to an effective field time or deadline for supplying the sample for the market research project. Yet further, in these aspects, scarcity of the first data items may correspond to scarcity of panelists having the attribute values that fulfill the criteria of the first data items.

It is envisioned that other implementations may address other tasks. For example, it is envisioned that other implementations may match medical patients to medications, treatments, and/or medical study opportunities. Additionally, it is envisioned that other implementations may match consumers to advertisements. Also, more generally, other implementations may match entities having known attributes to goods, services, or opportunities. One skilled in the art will readily apprehend how to extend the teachings of the present disclosure to these other implementations without undue experimentation.

Referring to FIG. 1, in some aspects, the present disclosure is directed to a solution to the problem of matching returning panelists or newly enrolled panelists to projects having relatively low acceptance rates, and of rerouting panelists who fail to qualify for one survey to another survey. Under the proposed solution, one or more computer processors may, at step 100, access a set of quota cells identified for the panelist and having priorities that are assigned to the quota cells. The one or more computer processors may, at step 102, select one or more of the quota cells by weighting random selection of market research projects according to the priorities assigned to their respective quota cells identified for the panelist. The one or more computers may further, at step 104, match the panelist to the market research project based on the selection.

As described with reference to FIG. 2, the proposed solution for matching panelists to projects may be implemented by one or more components of an apparatus for matching a panelist 200 to a market research project. Such an apparatus may implement an enrollment engine 202 that enrolls the panelists 200 in an attributes database 204 by collecting attribute values of the panelist via a panelist interface 206. The attributes database 204 may include a relational database as will be readily understood by one skilled in the art. The relational database may be used for running queries that are not as time sensitive as a panelist rerouting operation. The attributes database 204 may include a graph database that relates panelists to profile parameter value vertices by edges, and that relates profile parameter value vertices to quota cell vertices by edges corresponding to Boolean expressions for satisfying quota cell criteria. This graph database may be employed for running queries in rerouting operations. Enrollment engine 202 may create and/or edit panelist vertices and/or the edges relating panelist vertices to profile parameter value vertices. Example graph database implementations are described in greater detail in co-pending U.S. patent application Ser. No. ______ entitled Using a Graph Database to Match Entities by Evaluating Boolean Expressions and filed concurrently herewith by the assignee of the present application on Jan. 2, 2013. The disclosure of the aforementioned U.S. Patent Application is incorporated by reference herein in its entirety for any purpose. The disclosure of the aforementioned U.S. patent application is attached hereto as Appendix A. Appendix A forms part of the application. Any features of any embodiments described in Appendix A may be combined with each other or combined with any embodiments within the description and/or any other Appendices attached hereto.

The apparatus may additionally implement a project management engine 208 that interacts with a customer 210 via a customer interface 212 to obtain information about a survey 212 implemented by the customer. As will be readily understood by one skilled in the art, project management engine 208 may collect information about a project for supplying a sample for the survey, including targeted attributes, demographic quotas, and a link to the electronic survey 214 hosted at the customer's website. One or more data objects representing the project may be instantiated and maintained by project management engine 208 in projects database 216. Project management engine 208 may additionally create and/or edit entries in attribute database 204 to record, for example, the profile parameter value vertices, the quota cell vertices, and the edges corresponding to Boolean expressions for satisfying quota cell criteria.

Project management engine 208 may also assign priorities to quota cells of projects based on one or more conditions, such as: scarcity of panelists having the profile parameter values that satisfy the quota cell criteria, which may be defined in terms of actual scarcity of such panelists in the database, or may be defined as a scarcity/value proxy based on pricing of quota cells that reflects scarcity of the panelists fulfilling the quota cell criteria; percentage of progress, which may be defined in terms of number of registered starts or completes for a quota cell, versus the total number of starts or completes scheduled to have been achieved according to a field schedule for filling that quota cell on or before the project completion deadline; and/or elapsed effective field time for completion of the project, with a factor being defined for use as a measure of priority based on percentage of completion. In this sense, effective field time may take into consideration the time of day, days of the week, etc. with respect to panelist behavior, and when panelists are more likely to be available. Such priority assignment is described in greater detail in co-pending U.S. patent application Ser. No. ______ entitled Quota Cell Priority Determination to Match a Panelist to a Market Research Project and filed concurrently herewith by the assignee of the present application on Jan. 2, 2013. The disclosure of the aforementioned U.S. Patent Application is incorporated by reference herein in its entirety for any purpose. The disclosure of the aforementioned U.S. patent application is attached hereto as Appendix B. Appendix B forms part of the application. Any features of any embodiments described in Appendix B may be combined with each other and/or combined with any embodiments within the description and/or any other Appendices attached hereto.

The computer-implemented process of matching panelists to projects may principally be carried out by a panelist matching engine 218. The panelist matching engine 218 may interact with the panelist 200 via the panelist interface 206, and access the attribute database 204, to obtain a fit 220 that matches the panelist 200 to a market research project associated with a survey 214. Accomplishing the fit 220 may result, for example, in the panelist 200 being redirected to a website of the customer 210 where the survey 214 is hosted.

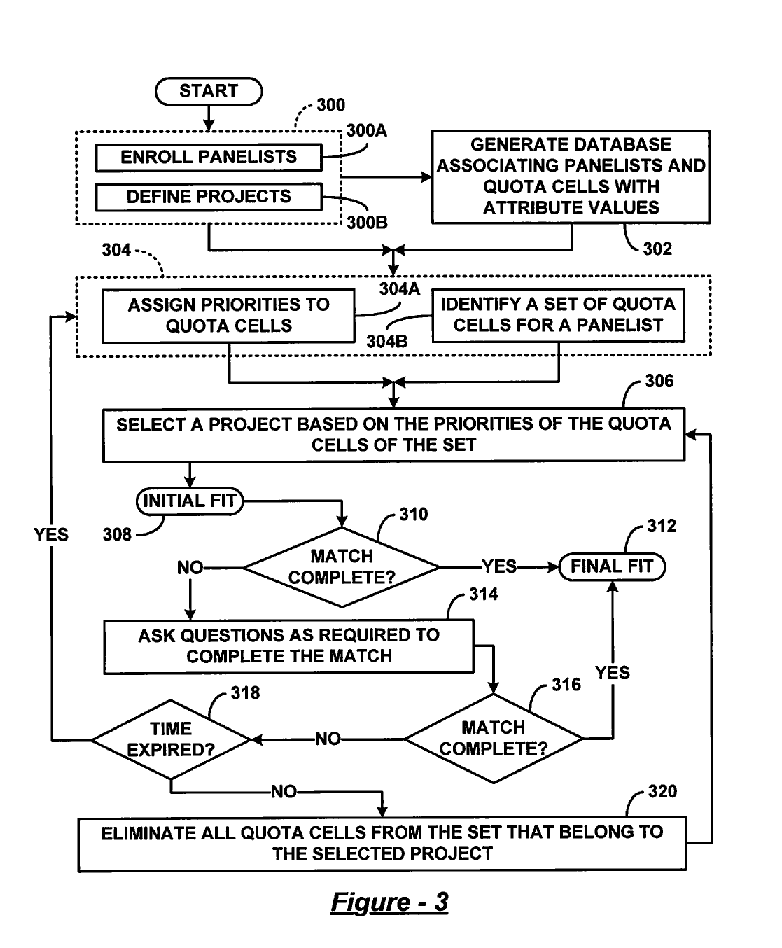

Turning now to FIG. 3, a method of operation for the market research apparatus may begin at step 300 by enrolling panelists at step 300A, and defining projects at step 300B. A database associating panelists and quota cells with attribute (i.e., profile parameter) values may be generated and/or updated at step 302. At step 304, priorities may be assigned to quota cells at step 304A, and a set of quota cells may be identified for a panelist at step 304B. At step 306, one of the market research projects may be selected based on the priorities of the quota cells identified for the panelist. This selection may result in an initial fit 308. However, it is possible, in some implementations, that the match is not a complete match.

An incomplete match may occur, for example, if no value for a profile parameter required by quota cell criteria has yet been recorded for the panelist. Alternatively or additionally, an incomplete match may be determined based on a profile parameter value being expired (i.e., a sufficient amount of time having passed for a previous identification for the profile parameter value identification to no longer be current), thus permitting an incomplete match even if the same or another value for that parameter was previously identified. Further, an event based mechanism may be employed that enables an incomplete match to occur due to a recorded event in a panelist's life that would indicate that certain profile parameter values may no longer be current or correct. If it is determined, at step 310, that the match is complete, then the initial fit 308 may be considered a final fit 312. Otherwise, at step 314, questions may be asked as required to complete the match. Any identifications obtained at step 314 may be employed to dynamically update the panelist's profile. If it is determined, at step 316, that the match is now complete, then the result may be the final fit 312. Otherwise, processing may return to a previous step depending on whether a predetermined amount of time (e.g., 15 seconds) has passed since the set of quota cells was identified at step 304B. This predetermined amount of time may reflect a rate at which the quota cell priorities are updated. If it is determined, at step 318, that the time has expired, then processing may return to step 300 for a new set of quota cells having updated priorities to be identified for the panelist. Otherwise, at step 320, all of the quota cells belonging to the selected market research project may be eliminated from the set of quota cells, and processing may return to step 306 for selection of another market research project.

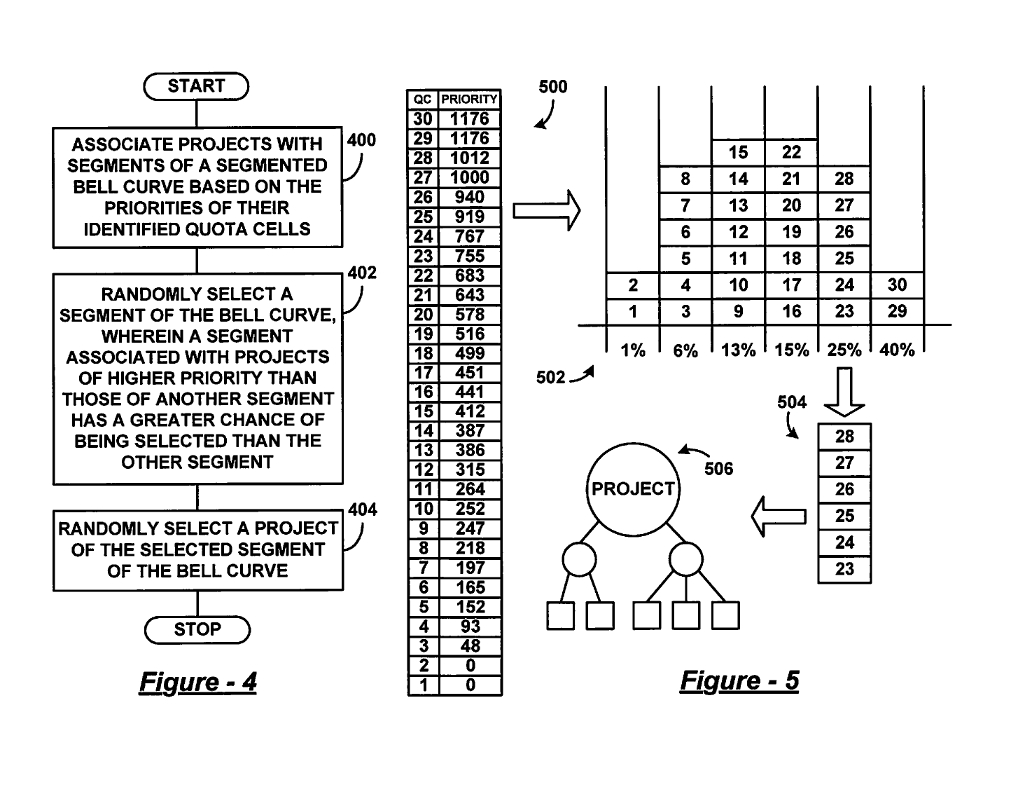

Turning now to FIG. 4, in some implementations, a computer-implemented process of weighting random selection of the market research projects according to priorities assigned to their respective quota cells identified for the panelist may include associating the market research projects, at step 400, with segments of a segmented bell curve based on the priorities of their respective quota cells identified for the panelist. The process may additionally include, at step 402, randomly selecting a segment of the bell curve, wherein a segment associated with quota cells of higher priority than those of another segment may have a greater chance of being selected than the other segment. Further, at step 404, the process may include randomly selecting a market research project of the selected segment of the bell curve. As already mentioned above, selection of a market research project in this fashion may match a panelist to that market research project, and result in the panelist being assigned to the project.

Referring to FIG. 5, an example execution of the process described above is provided using visual representations of data structures and objects generated and utilized by the computer implemented process. In the illustrative example, a set 500 of prioritized market research projects may contain thirty market research projects having quota cells that have been identified for the panelist. The data objects in the set 500 may be assigned market research project priorities based on the priorities of their respective quota cells identified for the panelist. For example, the set of quota cells identified for the panelist may have a quota cell from each quota group of each market research project that has at least one quota cell in the set of quota cells identified for the panelist. In some aspects, if a value is unknown for a quota group of an otherwise matching project, all of the quota cells in that quota group may be included in the set of quota cells. For a project having quota cells represented in the set of quota cells, a project priority may be determined based on the priorities of its respective quota cells in the set of quota cells. In some aspects, a priority of the quota cell having the highest priority may be used as the project priority. In other aspects, an average of the priorities of the quota cells of that project that are represented in the set of quota cells may be computed and used as the project priority. For example, a “consolidated priority score” for an execution of a project may be computed as the average of the maximum priorities of the matched or unknown quota cells in the various quota groups. Other techniques for determining the project priority based on the individual priorities of its quota cells identified for the panelist will be readily apparent to those skilled in the art.

In some aspects, the set 500 of prioritized market research projects may be sorted according to their respective project priorities. In the illustrated example, the priority-weighted random selection process may instantiate six data structures (e.g., matrix, list, table, etc.) to represent six segments of a segmented bell curve 502. Probabilities for selecting the data structures may be assigned in a predetermined fashion, such as 1%, 6%, 13%, 15%, 25%, and 40%. The market research projects of the set 500 may be assigned to these data structures based on their priorities, such that the highest priority market research projects are assigned to the data structure having the greatest probability of selection, and vice versa.

The market research projects may be divided among the data structures in such a way as to approximate a bell curve, thus associating the market research projects with segments of a segmented bell curve 502 based on the priorities. For example, the five percent of the market research projects having the highest priorities (e.g., market research projects 29-30) may be assigned to the data structure having the greatest chance of being selected (e.g., 40%), while the five percent of the market research projects having the lowest priorities (e.g., market research projects 1-2) may be assigned to the data structure having the lowest chance of being selected (e.g., 1%). Additionally, the next highest twenty percent of the market research projects having the remaining highest priorities (e.g., market research projects 23-28) may be assigned to the data structure having the next greatest chance of being selected (i.e., 25%), while the next twenty percent of the market research projects having the remaining lowest priorities (e.g., market research projects 3-8) may be assigned to the data structure having the next lowest chance of being selected (e.g., 6%). Also, the next highest twenty-five percent of the market research projects having the remaining highest priorities (e.g., market research projects 16-22) may be assigned to the data structure having the next greatest chance of being selected (i.e., 15%), while the next twenty-five percent of the market research projects having the remaining lowest priorities (e.g., quota cells 9-15) may be assigned to the data structure having the next lowest chance of being selected (e.g., 13%).

Once the segments of the segmented bell curve 502 are populated with all of the market research projects of the set 500, a segment 504 may be randomly selected according to the predefined weights, and a market research project 506 of that segment may be further randomly selected. In some implementations, this subsequent random selection of the particular market research project 506 of a segment 504 may also be weighted according to the priorities of the quota cells within the segment. In other implementations, the random selection of the market research project 506 of the segment 504 may not be weighted. Once the market research project 506 is selected, the panelist may be assigned to that market research project pending completion of the match.

If an attempt to completely match the panelist to the market research project fails, then the market research project 506 may be eliminated from the set 500. In some aspects, all quota cells associated with the market research project 506 may also be removed from the set of quota cells identified for the panelist. Once the market research project 506 is removed from the set 500, then the process may be repeated to select another market research project of the pruned set 500. This process may be repeated until a final fit is obtained.

Although the present invention and its advantages have been described in detail, it should be understood that various changes, substitutions and alterations may be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of matching a panelist to a market research project, the method comprising:
accessing, by one or more computer processors, a set of quota cells identified for the panelist and having priorities assigned thereto;
selecting, by the one or more computer processors, a market research project by weighting random selection of market research projects according to the priorities assigned to their respective quota cells identified for the panelist; and
matching, by the one or more computer processors, the panelist to the market research project based on the selection.

2. The method of claim 1, wherein weighting random selection of market research projects according to the priorities assigned to their respective quota cells identified for the panelist includes associating the market research projects with segments of a segmented bell curve based on the priorities assigned to their respective quota cells identified for the panelist.

3. The method of claim 2, wherein weighting random selection of market research projects according to the priorities assigned to their respective quota cells identified for the panelist includes randomly selecting a segment of the bell curve.

4. The method of claim 3, wherein a segment associated with market research projects of higher priority than those of another segment has a greater chance of being selected than the other segment.

5. The method of claim 3, wherein weighting random selection of market research projects according to the priorities assigned to their respective quota cells identified for the panelist includes randomly selecting a market research project of the selected segment of the bell curve.

6. The method of claim 1, further comprising:
identifying, by the one or more computer processors, the set of quota cells for the panelist by traversing a graph database in a manner constrained to profile parameter value vertices identified for the panelist.

7. The method of claim 6, wherein the graph database relates profile parameter value vertices to quota cell vertices by edges corresponding to Boolean expressions for satisfying quota cell criteria.

8. The method of claim 1, further comprising assigning priorities to the quota cells, by the one or more computer processors, based at least in part on percentage of progress of market research projects associated therewith.

9. The method of claim 1, further comprising assigning priorities to the quota cells, by the one or more computer processors, based at least in part on elapsed effective field time for completion of market research projects associated therewith.

10. The method of claim 1, further comprising assigning priorities to the quota cells, by the one or more computer processors, based at least in part on scarcity of quota cell criteria.

11. An apparatus for matching a panelist to a market research project, the apparatus comprising:
means for accessing, by one or more computer processors, a set of quota cells identified for the panelist and having priorities assigned thereto;
means for selecting, by the one or more computer processors, a market research project by weighting random selection of market research projects according to the priorities assigned to their respective quota cells identified for the panelist; and
means for matching, by the one or more computer processors, the panelist to the market research project based on the selection.

12. The apparatus of claim 11, wherein said means for selecting includes means for associating the market research projects with segments of a segmented bell curve based on the priorities assigned to their respective quota cells identified for the panelist.

13. The apparatus of claim 12, wherein said means for selecting includes means for randomly selecting a segment of the bell curve.

14. The apparatus of claim 13, wherein a segment associated with market research projects of higher priority than those of another segment has a greater chance of being selected than the other segment.

15. The apparatus of claim 13, wherein said means for selecting includes means for randomly selecting a market research project of the selected segment of the bell curve.

16. The apparatus of claim 11, further comprising:
means for identifying the set of quota cells for the panelist by traversing a graph database in a manner constrained to profile parameter value vertices identified for the panelist.

17. The apparatus of claim 16, wherein the graph database relates profile parameter value vertices to quota cell vertices by edges corresponding to Boolean expressions for satisfying quota cell criteria.

18. The apparatus of claim 11, further comprising means for assigning the priorities to the quota cells based at least in part on percentage of progress of market research projects associated therewith.

19. The apparatus of claim 11, further comprising means for assigning the priorities to the quota cells based at least in part on elapsed effective field time for completion of market research projects associated therewith.

20. The apparatus of claim 11, further comprising means for assigning the priorities to the quota cells based at least in part on scarcity of quota cell criteria.

21. A computer program product, comprising:
a nontransitory computer-readable medium, comprising:
code for causing a computer processor to access a set of quota cells identified for the panelist and having priorities assigned thereto;
code for causing a computer processor to select a market research project by weighting random selection of market research projects according to the priorities assigned to their respective quota cells identified for the panelist; and
code for causing a computer processor to match the panelist to the market research project based on the selection.

22. The computer program product of claim 21, wherein said code for causing a computer processor to select includes code for causing a computer processor to associate the market research projects with segments of a segmented bell curve based on the priorities assigned to their respective quota cells identified for the panelist.

23. The computer program product of claim 22, wherein said code for causing a computer processor to select includes code for causing a computer processor to randomly select a segment of the bell curve.

24. The computer program product of claim 23, wherein a segment associated with market research projects of higher priority than those of another segment has a greater chance of being selected than the other segment.

25. The computer program product of claim 23, wherein said code for causing a computer processor to select includes code for causing a computer to randomly select a market research project of the selected segment of the bell curve.

26. The computer program product of claim 21, wherein said nontransitory computer-readable medium further comprises:
code for causing a computer processor to identify the set of quota cells for the panelist by traversing a graph database in a manner constrained to profile parameter value vertices identified for the panelist.

27. The computer program product of claim 26, wherein the graph database relates profile parameter value vertices to quota cell vertices by edges corresponding to Boolean expressions for satisfying quota cell criteria.

28. The computer program product of claim 21, wherein said nontransitory computer-readable medium further comprises:
code for causing a computer to assign the priorities to the quota cells based at least in part on percentage of progress of market research projects associated therewith.

29. The computer program product of claim 21, wherein said nontransitory computer-readable medium further comprises:
code for causing a computer to assign the priorities to the quota cells based at least in part on elapsed effective field time for completion of market research projects associated therewith.

30. The computer program product of claim 21, wherein said nontransitory computer-readable medium further comprises:
code for causing a computer processor to assign the priorities to the quota cells based at least in part on scarcity of quota cell criteria.

31. A market research apparatus, comprising:
a memory that stores data relating to panelists and market research projects; and
a processor configured to:
access a set of quota cells identified for the panelist and having priorities assigned thereto;
select a market research project by weighting random selection of market research projects according to the priorities assigned to their respective quota cells identified for the panelist; and
match the panelist to the market research project based on the selection.

32. The apparatus of claim 31, wherein said processor is further configured to weight random selection of market research projects according to the priorities assigned to their respective quota cells identified for the panelist by associating the market research projects with segments of a segmented bell curve based on the priorities assigned to their respective quota cells identified for the panelist.

33. The apparatus of claim 32, wherein said processor is further configured to weight random selection of market research projects according to the priorities assigned to their respective quota cells identified for the panelist by randomly selecting a segment of the bell curve.

34. The apparatus of claim 33, wherein a segment associated with market research projects of higher priority than those of another segment has a greater chance of being selected than the other segment.

35. The apparatus of claim 33, wherein said processor is further configured to weight random selection of market research projects according to the priorities assigned to their respective quota cells identified for the panelist by randomly selecting a market research project of the selected segment of the bell curve.

36. The apparatus of claim 31, wherein said processor is further configured to:
identify the set of quota cells for the panelist by traversing a graph database in a manner constrained to profile parameter value vertices identified for the panelist.

37. The apparatus of claim 36, wherein the graph database relates profile parameter value vertices to quota cell vertices by edges corresponding to Boolean expressions for satisfying quota cell criteria.

38. The apparatus of claim 31, wherein said processor is further configured to:
assign priorities to the quota cells based at least in part on percentage of progress of market research projects associated therewith.

39. The apparatus of claim 31, wherein said processor is further configured to:
assign priorities to the quota cells based at least in part on elapsed effective field time for completion of market research projects associated therewith.

40. The apparatus of claim 31, wherein said processor is further configured to:
assign priorities to the quota cells based at least in part on scarcity of quota cell criteria.

41. A method of finding a first data item within a set based on a second data item, the method comprising:
accessing, by one or more computer processors, a set of criteria data items identified for the second data item, wherein the criteria data items represent criteria for matching the second data item to the first data items, and wherein the criteria data items have priorities assigned thereto;
selecting, by the one or more computer processors, a first data item by weighting random selection of first data items according to the priorities assigned to their respective criteria data items identified for the second data item; and
matching, by the one or more computer processors, the second data item to the first data item based on the selection.

42. The method of claim 41, wherein weighting random selection of first data items according to the priorities assigned to their respective criteria data items identified for the second data item includes associating the first data items with segments of a segmented bell curve based on the priorities assigned to their respective criteria data items identified for the second data item.

43. The method of claim 42, wherein weighting random selection of first data items according to the priorities assigned to their respective criteria data items identified for the second data item includes randomly selecting a segment of the bell curve.

44. The method of claim 43, wherein a segment associated with first data items of higher priority than those of another segment has a greater chance of being selected than the other segment.

45. The method of claim 43, wherein weighting random selection of first data items according to the priorities assigned to their respective criteria data items identified for the second data item includes randomly selecting a first data item of the selected segment of the bell curve.

46. The method of claim 41, further comprising:
identifying, by the one or more computer processors, the set of criteria data items for the second data item by traversing a graph database in a manner constrained to parameter value vertices identified for the second data item, wherein the graph database relates value vertices to criteria vertices by edges corresponding to Boolean expressions for satisfying the criteria for matching the second data item to the first data items.

47. The method of claim 41, further comprising:
assigning priorities to the criteria data items, by the one or more computer processors, based at least in part on at least one of:
scarcity of their respective first data items;
schedules for finding their respective first data items; or
scarcity of second data items that satisfy the criteria of the criteria data item.

48. An apparatus for finding a first data item within a set based on a second data item, the apparatus comprising:
means for accessing, by one or more computer processors, a set of criteria data items identified for the second data item, wherein the criteria data items represent criteria for matching the second data item to the first data items, and wherein the criteria data items have priorities assigned thereto;
means for selecting, by the one or more computer processors, a first data item by weighting random selection of first data items according to the priorities assigned to their respective criteria data items identified for the second data item; and
means for matching, by the one or more computer processors, the second data item to the first data item based on the selection.

49. The apparatus of claim 48, wherein said means for selecting includes means for associating the first data items with segments of a segmented bell curve based on the priorities assigned to their respective criteria data items identified for the second data item.

50. The apparatus of claim 49, includes means for randomly selecting a segment of the bell curve.

51. The apparatus of claim 50, wherein a segment associated with first data items of higher priority than those of another segment has a greater chance of being selected than the other segment.

52. The apparatus of claim 49, wherein said means for selecting includes randomly means for selecting a first data item of the selected segment of the bell curve.

53. The apparatus of claim 48, further comprising:
means for identifying, by the one or more computer processors, the set of criteria data items for the second data item by traversing a graph database in a manner constrained to parameter value vertices identified for the second data item, wherein the graph database relates value vertices to criteria vertices by edges corresponding to Boolean expressions for satisfying the criteria for matching the second data item to the first data items.

54. The apparatus of claim 48, further comprising:
means for assigning priorities to the criteria data items, by the one or more computer processors, based at least in part on at least one of:
scarcity of their respective first data items;
schedules for finding their respective first data items; or
scarcity of second data items that satisfy the criteria of the criteria data item.
